(19) United States
(12) Patent Application Publication
(10) Pub. No.: US 2020/0165740 A1
(43) Pub. Date: May 28, 2020

(54) STEPS FOR MAKING INDEX ON A TOOL

(71) Applicant: Yi-Fu Chen, Taichung City (TW)

(72) Inventor: Yi-Fu Chen, Taichung City (TW)

(21) Appl. No.: 16/198,861

(22) Filed: Nov. 22, 2018

(51) Int. Cl. C25D 9/02; B23K 26/362

(52) U.S. Cl. CPC C25D 9/02; B23K 2103/42; B23K 26/362

(57) ABSTRACT

The present invention provides steps of making an index in a tool, and includes a step of preparing a semi-finished tool by using machine to prepare a semi-finished tool; a step of first electro deposited coating to attach a transparent layer on the semi-finished tool by way of electro deposited-coating; a step of laser engraving to make at least one recess in the transparent layer by way of laser engraving, and the at least one recess communicates with the outer surface of the semi-finished tool; a step of second electro deposited coating to fill colored material in the at least one recess by way of electro deposited coating to make the top surface of the colored material be in flush with the top surface of the transparent layer, and a step of trimming to obtain a tool.

### BACKGROUND OF THE INVENTION

### 1. Fields of the Invention

The present invention relates to steps for making an index on a tool, and more particularly, to steps for making an index on a tool and the index is not removed from the tool.

### 2. Descriptions of Related Art

Tools such as screwdrivers or wrenches, are used frequently to tighten or loosen objects such as bolts, nuts or the like. The tools have to be chosen according to the sizes of the objects to be tightened so as to effectively drive the objects. Most of the tools include an index on the surface thereof to show the information of the specification, material, brands, etc., so that the users can easily pick the correct one. The conventional way to make the index is to press the information on the surface of the tool after the tool is completely made. Colored material is then filled in the notches or recesses formed in the surface of the tools. Some tools even use a sticker attached on the surface to show the information. The colored material can be worn out after a period of time of use, and the stickers are easily peeled off.

The present invention intends to provide steps for making an index for a tool to eliminate the shortcomings mentioned above.

### SUMMARY OF THE INVENTION

The present invention relates to steps of making an index in a tool, and comprises a step of preparing a semi-finished tool by using machine to prepare a semi-finished tool; a step of first electro deposited coating to attach a transparent layer on the semi-finished tool by way of electro deposited-coating; a step of laser engraving to make at least one recess in the transparent layer by way of laser engraving, and the at least one recess communicates with the outer surface of the semi-finished tool; a step of second electro deposited coating to fill colored material in the at least one recess by way of electro deposited-coating to make the top surface of the colored material be in flush with the top surface of the transparent layer, and a step of trimming to obtain a tool.

Preferably, the at least one recess forms a distinguishable portion which includes characters, numbers, codes or patterns, or a combination of the characters, the numbers, the codes or the patterns.

Preferably, the top surface of the colored material and the top surface of the transparent layer each are a smooth surface.

Preferably, the step of trimming uses polishing machine or a sand-grinding machine.

Preferably, the transparent layer and the colored material are resin with additives.

Preferably, the transparent layer and the colored material have different colors.

The primary object of the present invention is to provide an index on the outer surface of a tool, and the index includes colored material filled in at least one recess defined in the outer surface of the tool by way of electro deposited-coating so that the colored material will not be removed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the present invention;

FIG. 2 shows that the first electro deposited-coating is applied to the outer surface of the semi-finished tool;

FIG. 3 illustrates the step of laser engraving of the present invention;

FIG. 4 illustrates the step of second electro deposited-coating, and

FIG. 5 is a perspective view to show the index formed on a tool by the steps of the present invention.

### DETAILED DESCRIPTION OF THE PREFERRED EMBODIMENT

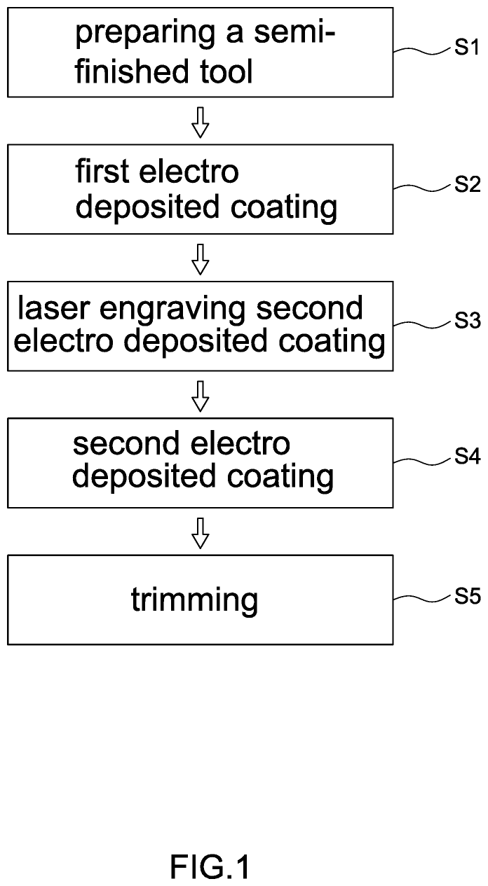

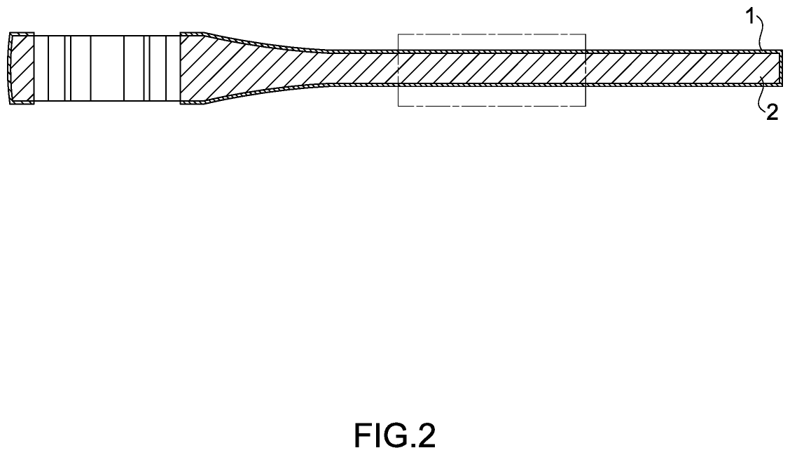

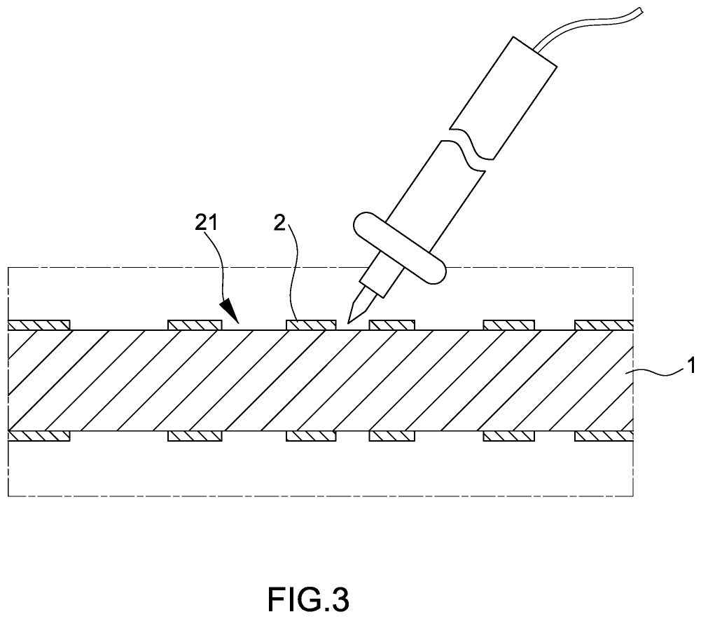

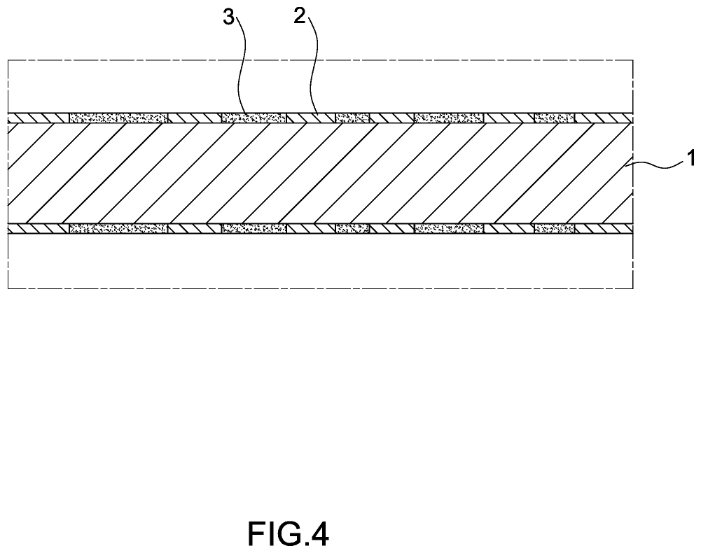

Referring to FIGS. 1 to 4, the steps of making an index in a tool of the present invention comprises the following steps:

a step S1 of preparing a semi-finished tool: using machine to prepare a semi-finished tool 1 which can be a socket, a wrench, a bolt, a nut or the like;

a step S2 of first electro deposited coating: attaching a transparent layer 2 on the outer surface of the semi-finished tool 1 by way of electro deposited-coating;

a step S3 of laser engraving: making at least one recess 21 in the transparent layer 2 by way of laser engraving, the at least one recess 21 communicating with the outer surface of the semi-finished tool 1;

a step S4 of second electro deposited coating: filling colored material 3 in the at least one recess 21 by way of electro deposited-coating, a top surface of the colored material 3 being in flush with a top surface of the transparent layer 2; and

a step S5 of trimming: trimming the semi-finished tool 1 to obtain a tool 4.

The at least one recess 21 forms a distinguishable portion which includes characters, numbers, codes or patterns, or a combination of the characters, the numbers, the codes or the patterns. The step of trimming uses a polishing machine or a sand-grinding machine.

The electro deposited coating applies coatings which generally have a very uniform coating thickness without porosity to objects such as metals. Even complex fabricated objects can easily be coated, both inside cavities as well as on the outside surfaces. The electro deposited coating is normally automated and requires less human labor than other coating processes. Therefore, transparent layer 2 is securely attached to the outer surface of the semi-finished tool 1, and the colored material 3 is the at least one recess 21 is not removed. The transparent layer 2 and the colored material 3 are resin with additives, and the transparent layer 2 and the colored material 3 have different colors which provide very good distinguishable features.

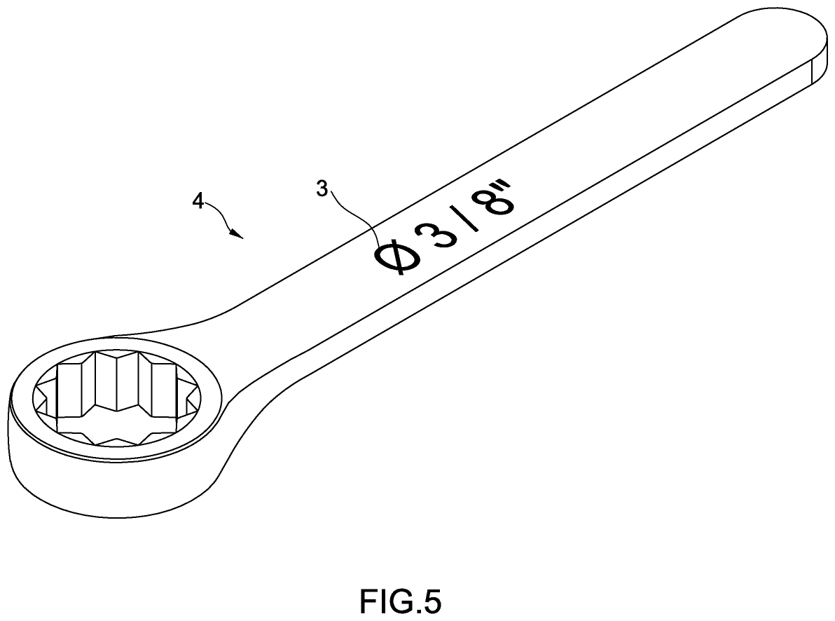

The top surface of the colored material 3 and the top surface of the transparent layer 2 each are a smooth surface. It is noted that the step of trimming uses a polishing machine or a sand-grinding machine to selectively make the outer surface of the tool 4 to be smooth, anti-slip or any desired surface condition. Of course, a rubber made coat can also be used to the outer surface of the tool 4. As shown in FIG. 5, the number of the at least one recess 21 can be multiple and have different shapes and sizes. The present invention makes the tools 4 have better distinguishable features, the colored material 3 exist for a longer time period and is not be removed.

While we have shown and described the embodiment in accordance with the present invention, it should be clear to those skilled in the art that further embodiments may be made without departing from the scope of the present invention.

What is claimed is:

1. Steps of making an index in a tool, comprising:
a step of preparing a semi-finished tool: using machine to prepare a semi-finished tool;
a step of first electro deposited coating: attaching a transparent layer on an outer surface of the semi-finished tool by way of electro deposited-coating;
a step of laser engraving: making at least one recess in the transparent layer by way of laser engraving, the at least one recess communicating with the outer surface of the semi-finished tool, and
a step of second electro deposited coating: filling colored material in the at least one recess by way of electro deposited-coating, a top surface of the colored material being in flush with a top surface of the transparent layer;
a step of trimming: trimming the semi-finished tool to obtain a tool.

2. The steps as claimed in claim 1, wherein the at least one recess forms a distinguishable portion which includes characters, numbers, codes or patterns, or a combination of the characters, the numbers, the codes or the patterns.

3. The steps as claimed in claim 2, wherein the top surface of the colored material and the top surface of the transparent layer each are a smooth surface.

4. The steps as claimed in claim 3, wherein the step of trimming uses polishing machine or a sand-grinding machine.

5. The steps as claimed in claim 4, wherein the transparent layer and the colored material are resin with additives.

6. The steps as claimed in claim 5, wherein the transparent layer and the colored material have different colors.
